(19) United States
(12) Patent Application Publication
(10) Pub. No.: US 2015/0225274 A1
(43) Pub. Date: Aug. 13, 2015

(54) PROCESS AND APPARATUS FOR FORMING MAN-MADE VITEROUS FIBRES

(71) Applicant: ROCKWOOL INTERNATIONAL A/S, Hedehusene (DK)

(72) Inventors: Mette Solvang, Roskilde (DK); Svend Grove-Rasmussen, Roskilde (DK); Lars Elmekilde Hansen, Roskilde (DK)

(73) Assignee: Rockwool International A/S, Hedehusene (GB)

(21) Appl. No.: 14/434,561

(22) PCT Filed: Oct. 11, 2013
(86) PCT No.: PCT/EP2013/071368

§ 371 Date: Apr. 9, 2015

(30) Foreign Application Priority Data
Oct. 12, 2012 (EP) 12188444.9

(51) Int. Cl. C03B 5/183; C03B 5/027; C03B 5/28; C03B 37/04; C03B 5/235

(52) U.S. Cl. CPC C03B 5/183; C03B 37/04; C03B 5/2356; C03B 5/2353; C03B 5/28; C03B 5/027

(57) ABSTRACT

A melt for use in the production of man-made vitreous fibres may be formed in a circulating combustion chamber (20) by melting particulate material. The material is collected in a base region of the combustion chamber (26), where it can be heated using submerged heating means (40). The submerged heating increases the homogeneity of the melt within the melt pool (30), the coherence of which is maintained by the use of a siphon (50) to extract melt from the combustion chamber.

### FIELD OF THE INVENTION

The present invention relates to the production of man-made vitreous fibres (MMVF) from a mineral melt. In particular, but not exclusively, the present invention relates to the combustion of particulate mineral material in a cyclone furnace to form an appropriate mineral melt.

### BACKGROUND TO THE INVENTION

A known method of forming a mineral melt for the production of MMVF is by means of a shaft furnace in which a self-supporting stack of inorganic particulate material is heated by combustion of combustible material in the furnace. The stack gradually melts and is replenished from the top, with melt draining down the stack and discharged from the bottom section of the furnace. Furnaces used for this purpose are commonly referred to as cupola furnaces.

Cupola furnaces have a number of disadvantages in the production of mineral melt. In addition to the difficulty of achieving desired levels of efficiency, a further disadvantage arises due to the fact that it is necessary for the stack of material to be sufficiently permeable for combustion gases. This limits the particulate material that can be used in cupola furnaces, and in particular prevents the use of fine particulate material since this does not allow sufficient permeability for the combustion gas to pass through the shaft of the furnace to enable combustion of the combustible material. Accordingly, if the particulate material to be melted is in a finely divided form, it must first be formed into briquettes. This adds additional complexity and cost to the process and also reduces the quality of the ultimate melt as a binding agent is normally required for formation of such briquettes.

To overcome some of these disadvantages, cyclone furnaces have been proposed. In such furnaces, the particulate material which is to be melted is introduced entrained in a combustion gas together with fuel such as powdered coal. The fuel is combusted as the combination of materials circulate in a circulating combustion chamber. This causes the particulate material to start melting to form a mineral melt, and the mineral melt together with the remaining particulate material is thrown onto the side walls of the chamber and flows down these to an outlet. The output of the outlet is then either processed directly or is collected in a separate settling tank where further refining processes may occur before the melt is extracted for use in a process for forming MMVF.

An example of the principles of a cyclone furnace can be found in U.S. Pat. No. 3,077,094. This document describes a furnace for the melting of a glass batch. Particulate material is delivered in a gaseous suspension to a melting region formed in the upper part of a chamber. The gaseous mixture is introduced tangentially into the chamber so that it takes a helical path through the chamber. Molten glass is formed and is thrown against the chamber walls. The molten glass then flows downwardly across the walls until it leaves the chamber via a central flow outlet.

In one embodiment described in U.S. Pat. No. 3,077,094, the molten glass coalesces as it flows through the bottom of the chamber. This effect is achieved through the use of a restricted flow outlet. The molten glass can then be further fined as it passes through this region using electrode heaters which raise the temperature of the glass, thereby reducing viscosity and assisting in the escape of gases still present in the melt.

A further example of a melting process is described in U.S. Pat. No. 4,632,687. Again this document relates to the melting of a glass batch. In this process, a glass material is introduced with an ash containing fuel into a circulating combustion chamber. The document describes that a liquefaction stage occurs in the combustion chamber, while a distinct refining stage is undertaken in a separate settling tank. Exhaust gases from the combustion of the fuel in the liquefaction stage are removed from the combustion chamber through an exhaust outlet, while the melt falls through a separate outlet into the settling tank where it is further refined using a submerged combustion technique.

The submerged combustion stage is arranged to adjust the oxidation of the melt in order to increase the transmittance, i.e. reduce the colour, of the glass.

The above furnaces are not directed specifically towards the production of MMVF. In contrast, European patent publication no. EP1944272 is directed towards a cyclone furnace for the production of a mineral melt particularly suited to the production of MMVF. In particular, the apparatus and method described in that document is designed to produce a mineral melt having the right properties for the production of MMVF in an efficient manner.

One particular aspect of EP1944272 is that unlike the furnaces described above, the approach of this document does not require a settling tank but instead comprises the collection of the mineral melt in the combustion chamber itself. This reduces the size of the apparatus and also increases the overall efficiency of the apparatus as the heat of the combustion chamber can be used to maintain the temperature of the melt pool.

In the arrangement of the EP1944272, the production of significant amounts of melt is however limited due to the difficulties of controlling the conditions of the melt. In particular, controlling the homogeneity of the melt is a challenge within the combustion chamber. This difficulty increases as the volume of the melt pool increases. For example, temperature differentials can arise across the melt pool, altering properties such as the viscosity of the melt. Control of such variation is important in order to ensure the quality of the fibres produced in a subsequent fiberising process.

### SUMMARY OF THE INVENTION

According to a first aspect of the present invention, there is provided a method of making man-made vitreous fibres (MMVF), comprising:
providing a circulating combustion chamber;
injecting particulate fuel, particulate mineral material and combustion gas into an upper region of the combustion chamber and combusting the fuel, thereby melting the particulate mineral material to form a mineral melt;
collecting the mineral melt in a base region of the combustion chamber;
heating the collected mineral melt in the base region of the combustion chamber by submerged heating;
extracting the collected mineral melt from the combustion chamber via an outlet comprising a siphon; and
forming MMVF from the extracted mineral melt.

According to a second aspect of the present invention, there is provided a cyclone furnace, comprising
a circulating combustion chamber;
one or more inlets for injecting particulate fuel, particulate mineral material and combustion gas into an upper region of the combustion chamber for combusting the fuel, thereby melting the particulate mineral material to form a mineral melt which collects in a base region of the combustion chamber;
submerged heating means for directly heating the collected mineral melt in the base region of the combustion chamber, wherein the chamber is integrally formed and the base region is not provided separately; and
an outlet for extracting the collected mineral melt from the combustion chamber, wherein the outlet comprises a siphon.

The present invention provides an integrated, efficient and compact solution for the production of high quality mineral melt for the production of MMVF. In particular, particulate mineral material is melted in a circulating combustion chamber with the aid of a combustion gas and fuel, and the mineral melt is collected in a melt pool at the bottom of the circulating combustion chamber. The quality of the mineral melt is found to be improved by submerged heating of the collected mineral melt. The submerged heating of the mineral melt improves the homogeneity of the melt by introducing turbulence within the melt pool, thus mixing the melt pool to reduce variations in both temperature and composition.

The siphon acts to maintain a constant level of the pool of collected mineral melt, ensuring that the homogenising effect of the submerged heating of the melt is given sufficient time to provide benefits. In particular, whereas previous approaches have aimed to reduce residence time within the combustion chamber in order to avoid the establishment of temperature differentials, the present invention may take advantage of the residence of the melt to increase homogeneity through submerged heating. In particular, it is believed that bubbles included in the melt are allowed to escape from the melt during the submerged heating.

The use of both a siphon and submerged heating has several benefits over the prior art. Unlike the system of U.S. Pat. No. 3,077,094, where properties such as melt viscosity must also be controlled, melt discharge rate in the present invention can be controlled by feed rate of raw material alone since the outlet is a siphon. Combining the siphon with submerged heating also affords benefits over the system of European patent publication no. EP1944272. In this system there is a risk of building up a “dead zone” of frozen melt as the siphon only removes material from one side of the chamber. The present invention allows for mixing and heating in the melt pool, preventing this potential undesirable effect.

In some preferred embodiments, the step of submerged heating of the collected mineral melt comprises electrode heating of the collected mineral melt. In this technique, electrodes are provided submerged within the collected mineral melt and a potential difference is applied between the electrodes. This causes heating of the melt.

In other preferred embodiments, the submerged heating of the collected mineral melt may comprise carrying out a submerged combustion process within the mineral melt. Submerged combustion processes may comprise the provision of combustible material directly into the melt. Combustion of this material within the melt causes the heating of the melt and introduces additional turbulence, thereby assisting in the improved homogeneity of the melt.

In particularly preferred embodiments, the submerged combustion process comprises the injection of additional fuel and combustion gas through one or more burner lances extending through one or more sidewalls of the combustion chamber. More preferably, the burner lances are angled downwardly from the sidewalls of the combustion chamber. By orientating the burner lances in this manner, the risk that melt will ingress into the lances is reduced. This can be particularly important during the initial firing up of the combustion chamber and when shutting down the process, since at these stages submerged combustion may not be taking place. Nevertheless, in alternative embodiments, the burner lances may be arranged in another orientation, and, for example, may extend horizontally or vertically, or extend through the bottom wall of the combustion chamber.

Preferably, the position of the siphon is adjustable in height. An adjustable siphon height can be arranged to control the level of the collected mineral melt within the combustion chamber. In this manner, the volume of collected mineral melt within the chamber can be controlled as appropriate. This can, for example, be used to adjust the residence time of the melt within the combustion chamber, thereby ensuring that sufficient mixing of the melt takes place. Additionally, the height location of the siphon can be used to control the height of the melt pool during initial firing up and for emptying the combustion chamber after production.

In a preferred embodiment, the primary combustion gas is oxygen-enriched air which contains at least 25% oxygen by volume. The oxygen-enriched air may be pure oxygen. By using combustion gas which has an oxygen level higher than that of air, the volume of gases required for combustion gas can be reduced, enabling the combustion chamber to be even more compact. Furthermore, the volume of combustion gas is proportional to the energy needed to produce the melt so the use of oxygen-enriched combustion gas can increase the energy efficiency of the process. Moreover, using oxygen-enriched combustion gas also reduces the amount of nitrogen introduced into the system and hence also reduces the production of harmful NOx gases.

Preferred embodiments further comprise injecting secondary combustion gas above the mineral melt, thereby inducing combustion of any char produced by the initial pyrolysis during combustion of the particulate fuel. This has been found to offer significant improvements in energy efficiency while maintaining a good quality of mineral melt suitable for the production of MMVF.

Particulate fuels, such as coal, combust in a two-stage process. In the first stage, which is known as pyrolysis, the volatile compounds burn very quickly with rapid evolution of gas. This generates char particles which are rich in carbon. The second stage is combustion of the char particles and is typically much slower than the first stage. As such, while the first stage of combustion may occur almost instantaneously when a fuel particle enters the combustion chamber, the second stage does not normally occur unless the fuel has significant residence time.

Char in the mineral melt influences the quality of mineral fibres that can be produced. It is found that the injection of a secondary combustion gas above the mineral melt can significantly increase the rate at which the combustion of the char takes place. This avoids the need for a pre-combustion or secondary combustion chamber to allow the char to combust, and therefore enables a more compact approach.

In preferred embodiments, the secondary combustion gas is oxygen-enriched air which contains at least 25% oxygen by volume. Additional oxygen can increase the rate of combustion of char which is otherwise inhibited by a low level of oxygen as result of the exhaustion of the oxygen introduced in the primary combustion gas by the pyrolysis stage of combustion.

Preferably, the step of forming the MMVF is carried out using a centrifugal fiberising apparatus. Centrifugal fiberising apparatuses are particularly suited to the production of MMVF from a mineral melt. Preferably, the centrifugal fiberising apparatus is either a spinning cup (internal centrifugation) or a cascade spinner (external centrifugation). Centrifugal fiberising apparatuses of these types are found to be particularly effective in the production of MMVF.

### BRIEF DESCRIPTION OF THE DRAWINGS

Preferred embodiments of the present invention will be described with reference to the accompanying FIGURE, in which:

FIG. 1 illustrates a system for forming MMVF comprising a cyclone furnace in accordance with a first preferred embodiment of the present invention.

### DETAILED DESCRIPTION

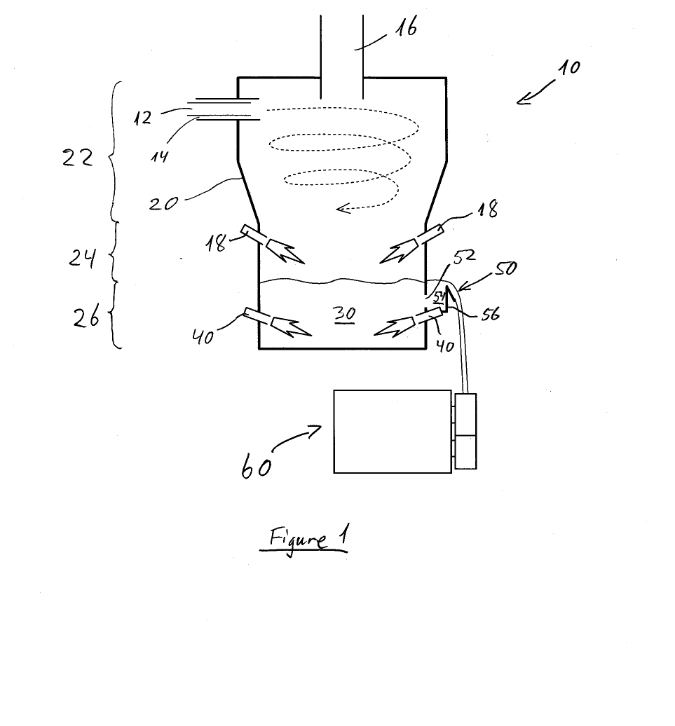

Referring to FIG. 1, a system for forming MMVF is shown. The system comprises a cyclone furnace 10 and a centrifugal fiberising apparatus 60. The cyclone furnace 10 comprises a circulating combustion chamber 20. The circulating combustion chamber can be considered as comprising three regions, referred to from the top of the chamber as an upper region 22, a central region 24 and a base region 26. The circulation chamber has rotational symmetry around a vertical axis and comprises cylindrical and frustoconical sections. The skilled person will recognise that the exact geometry of the chamber 20 may be chosen as appropriate. However, rotational symmetry offers particular benefits for cyclonic progression of combustion materials within the chamber 20.

The chamber is integrally formed. As such, the chamber is formed of a single part, rather than a plurality of separate sections. In particular, the base region 26 which collects melt from the process, as described below, is not provided separately. This compact design is advantageous in practice. For example, the diameter of the base region 26 does not exceed that of the upper region 22, in contrast to many conventional designs which use a large separate settling tank for collecting and refining the melt.

The provision of a compact chamber 20 can, amongst other advantages, reduce energy losses related to surface area. Preferably, the volume of the chamber 20 is less than 25 m³, more preferably less than 20 m³ or 15 m³ and can be less than 10 m³.

The cyclone furnace further comprises a particulate inlet 12 and a gas inlet 14 in the upper region 22 of the chamber 20. The gas inlet 14 concentrically surrounds the particulate inlet 12, while both inlets 12, 14 are offset from the vertical axis of symmetry of the combustion chamber. As such, materials injected through the inlets 12, 14 are offset from the central axis of the chamber 20 and a circulating movement of the injected material is imposed as indicated by the dotted, helically shaped arrow.

Although only a single particulate inlet 12 and a single gas inlet 14 are shown in FIG. 1, multiple inlets of each kind may be incorporated into the chamber 20. For example, in some embodiments, it may be preferable to introduce an additional gas inlet designed to introduce gas at a different speed to that introduced by the gas inlet 14. A speed differential can be useful to create turbulence and encourage the adequate mixing of particulate material.

The cyclone furnace 10 further comprises an exhaust outlet 16 for carrying exhaust gases from the chamber 20. The exhaust outlet 16 is preferably aligned with the axis of the chamber and formed through the top of the chamber 20. Due to the circulating movement of the injected material the hot spent gases naturally rise to this point and can exit the chamber 20.

The cyclone furnace 10 further comprises one or more secondary inlets 18 for providing secondary combustion gas. Additionally, secondary fuel may be supplied through the secondary inlets 18.

FIG. 1 illustrates a melt pool 30 in the bottom region of the chamber 20. The cyclone furnace 10 further comprises submerged heating means 40 submerged within the melt pool 30. In this preferred embodiment, the heating means 40 is a submerged combustion apparatus. In particular, the submerged combustion apparatus 40 comprises a plurality of lances extending through the sidewalls of the chamber 20 by which a mixture of combustion gas and fuel can be injected into the melt pool 30. This mixture combusts in the pool 30, thereby directly heating the melt pool 30. “Direct” or “submerged” heating of the melt pool 30 means the provision of a heat source within the pool itself, rather than by means of an external heat source.

A siphon 50 is provided as the outlet for the chamber 20 for extracting the melt from the melt pool 30. The siphon 50 comprises an opening 52 in a side wall of the chamber and an intermediary melt bath 54. The intermediary melt bath comprises an outlet barrier 56 over which melt is extracted, the outlet barrier extending above the height of the opening 52. In this manner melt is extracted from the chamber 20 when the height of the melt pool 30 exceeds that of the outlet barrier 56. The skilled person will recognise that the height of the opening 52 shown in FIG. 1 is for illustrative purposes only, and that in practice the opening 52 may be disposed lower or higher within the chamber 20 as desired.

The position of the siphon is preferably adjustable in height. In particular, the height of the outlet barrier 56 may be adjusted, thereby adjusting the height of the melt pool 30 within the chamber 20. The adjustment may be actuated manually or may be automated for a particular sequence of use of the cyclone furnace 10.

Melt extracted from the chamber 20 via the siphon 50 is transferred to a centrifugal fiberising apparatus 60, where it is used to form MMVF. Centrifugal fiberising apparatuses that may be used in this context may include cascade spinners or spinning cups, although alternative apparatus for forming mineral fibres may also be used. Beneficially, the cyclone furnace 10 of the preferred embodiment can transfer melt directly to the centrifugal fiberising apparatus 60 without the need for an intermediate settling tank or similar. Nevertheless, additional processing steps for the melt can be incorporated between the chamber 20 and the centrifugal fiberising apparatus 60 if so desired.

In use, particulate mineral material, particulate fuel and primary combustion gas is introduced through inlets 12, 14 into the combustion chamber, and combustion of the fuel cause melting of the particulate mineral material.

The particulate mineral material is any material that is suitable for making MMVF which can be glass fibres or stone or slag fibres. The raw materials used as the particulate mineral melt material can be selected from a variety of sources as is known. These include basalt, diabase, nepheline syenite, glass cullet, bauxite, quartz sand, limestone, rasorite, sodium tetraborate, dolomite, soda, olivine sands, phonolite, K-feldspar, garnet sand and potash. The mineral material can also be waste materials such as MMVF which have already been used or which have been rejected before use from other processes.

The particulate mineral material, which is melted in the chamber 20 to produce the mineral melt, is introduced into the upper region 22 of the chamber 20 so that it becomes suspended in the gases therein. The point at which the particulate mineral material is added is not critical and it can be mixed with the fuel and injected through a feed pipe shared with the fuel. However, in some preferred embodiments the particulate mineral material is introduced into the burning fuel. This can be achieved by adding the particulate mineral material into the chamber through an inlet in a conventional way, for example at or near to the top of the chamber.

The particulate fuel used in the present invention is typically a fuel which burns in a two-stage process involving initial pyrolysis to form a char particle, followed by combustion of the char particle. The particulate fuel can be in liquid or solid form. Where the fuel is a liquid, it can be used in the form of droplets, i.e., particles of liquid fuel. In this embodiment, the fuel can be particles of petroleum oil or other carbon based liquids.

However, the particulate fuel in the present invention is preferably solid. It is generally a carbonaceous material and can be any particulate carbonaceous material that has a suitable calorific value. The calorific value can be relatively low, for instance as low as 10000 kJ/kg or even as low as 5000 kJ/kg. Thus it may be, for instance, dried sewage sludge or paper waste. Preferably it has higher calorific value and may be spent pot liner from the aluminium industry, coal containing waste such as coal tailings, or powdered coal.

In a preferred embodiment, the fuel is powdered coal and may be coal fines but preferably some, and usually at least 50% and preferably at least 80% and usually all of the coal is made by milling lump coal, for instance using a ball mill. The coal, whether it is supplied initially as fines or lump, may be good quality coal or may be waste coal containing a high inorganic content, for instance 5 to 50% inorganic with the balance being carbon. Preferably the coal is mainly or wholly good quality coal for instance bituminous or sub-bituminous coal (ASTM D388 1984) and contains volatiles which promote ignition.

The fuel particles preferably have a particle size in the range from 50 to 1000 μm, preferably about 50 to 200 μm. Generally at least 90% of the particles (by weight) are in this range. The average is generally about 70 μm average size, with the range being 90% below 100 μm.

The fuel can be fed into the chamber through the inlet 12 in a conventional manner to give a stream of fuel particles. This normally involves the use of a carrier gas in which the fuel particles are suspended. The carrier gas can be air, oxygen-enriched air or pure oxygen preferably at ambient temperature to avoid flashbacks or a less reactive gas such as nitrogen. The carrier gas is considered to be part of the primary combustion gas. The primary combustion gas as a whole, which includes the carrier gas and other gas injected into the upper region of the chamber, preferably has more oxygen than is typically present in air. The inlet 12 is preferably cylindrical.

Primary combustion gas is introduced via the particulate inlet 12 and the gas inlet 14 into the upper region 22 of the chamber 20 and can be at ambient temperature or can be preheated. When the gas is heated, it is often pre-heated to between 300 and 600° C., often to around 500 to 550° C. The primary combustion gas is enriched with oxygen compared to air and has at least 25% oxygen by volume, whereas air normally has about 21% by volume. By oxygen-enriched air it is meant that the gas contains more oxygen than is naturally present in air and can, in addition, contain other gases that are naturally present in air. It can also contain other gases that are not normally present in air, such as propane or methane, providing the total level of oxygen remains over that normally present in air.

The primary combustion gas may be oxygen-enriched air which comprises at least 30% or 35%, such as at least 50%, such as at least 70% oxygen by volume or pure oxygen. In one embodiment, to optimise energy savings associated with the use of oxygen, with the increase cost of oxygen compared to air, the air comprises 30 to 50% oxygen. Where pure oxygen is used it is preferably at ambient temperature, rather than being preheated.

As indicated above, the primary combustion gas which is introduced through the particulate inlet 12 may have fuel suspended in it, especially when the gas is at a relatively low temperature. The fuel should not begin to combust in the fuel pipe before it enters the chamber (a phenomenon known as “flash back”) so relatively low gas temperatures are needed in this environment. However, the primary combustion gas which is introduced separately through the gas inlet may be at a higher temperature. The gas inlet 14 is preferably located in the vicinity of the fuel feed pipe so that the combustion gas is directed into the chamber 20 in the same region as the fuel, to allow for efficient mixing.

Whether or not the fuel and combustion gas are introduced together, the speed at which the combustion gas is injected into the chamber is relatively low (preferably between 1 and 50 m/s), so as to minimise wear of the apparatus. When the fuel and mineral material are suspended in the combustion gas, the speed is preferably between 5 and 40 m/s. When they are introduced separately, which is preferred, the injection speed of the fuel is preferably 20 to 40 m/s.

It is desirable to ensure that the particulate fuel is mixed rapidly and thoroughly with the primary combustion gas as this ensures that the fuel is ignited rapidly so that combustion starts almost immediately after introduction into the chamber. Having thorough mixing also ensures that the residence time of the fuel particles in the primary combustion gas is more uniform thereby leading to more efficient fuel combustion.

To help ensure rapid and thorough mixing an additional gas can be introduced in the upper region which travels at a higher speed than the primary combustion gas and the particulate fuel and, due to the speed differential, causes turbulence of the stream of fuel particles thereby breaking up the stream and ensuring rapid mixing. The additional gas is generally much less voluminous than the combustion gas and typically makes up less than 40% of the total gas injected into the combustion chamber, preferably between 10 and 30%. The additional gas can be any gas including air, nitrogen, oxygen, or a flammable gas such as propane or butane. The additional gas may be injected from an inlet so that it is adjacent the stream of fuel particles in the chamber but is preferably injected to an inlet that concentrically surrounds the fuel inlet. This concentric arrangement leads to efficient mixing, particularly where the additional gas inlet has a converging nozzle at its opening. The additional gas is preferably travelling at least 100 m/s faster than the fuel and the combustion gas, usually at least 250 m/s, preferably at least 300 m/s. In the most preferred embodiment, the injection speed of the additional gas is sonic or supersonic, i.e, at or above the speed of sound.

Alternatively, the primary combustion gas itself is pure oxygen travelling at least 100 m/s faster than the fuel, usually at least 250 m/s. The oxygen primary combustion gas may be injected from an inlet adjacent to the stream of fuel particles but, as mentioned above, in the preferred embodiment the gas inlet 14 concentrically surrounds the particulate inlet 12 through which the fuel is delivered.

So, as the fuel and combustion gas is introduced into the chamber 20, the fuel initially undergoes the pyrolysis stage of combustion. The heat generated by this causes the particulate mineral material to melt, and the molten material is flung to the sides of the chamber by the circulating motion of the gas and material. The melt collects on the side walls of the chamber 20, flows downwardly and is collected in the melt pool 30.

Pyrolysis of the fuel also creates char particles. Secondary combustion gas is introduced through the secondary inlets 18 to increase the rate of the secondary combustion phase during which the char particles are consumed.

As with the primary combustion gas, the secondary combustion gas can be at ambient temperature or preheated and contains at least 25% oxygen. The secondary combustion gas can be oxygen-enriched air which comprises at least 30% or 35%, such as at least 50%, such as at least 70% oxygen by volume, or between 30 and 50% oxygen or pure oxygen. Throughout the description “pure oxygen” is used to mean oxygen of 92% purity or more obtained by, for example, the vacuum pressure swing absorption technique (VPSA) or it may be almost 100% pure oxygen obtained by a distillation method. The secondary combustion gas can be introduced in any conventional manner but is preferably introduced using an inlet which has a converging nozzle, otherwise known as a lance.

The secondary combustion gas can be injected from one inlet 18 in the central region 24 but is preferably injected from at least two, most preferably more than two such as three, four, five or six, preferably four inlets.

The addition of secondary combustion gas in the central region 24 is very effective at ensuring full burn-out of the char particles created following pyrolysis in the upper region. Adding oxygen at this point has been found to be much more effective than simply adding additional oxygen with the primary combustion gas in the upper region 22. The secondary combustion gas makes up less than half of the total combustion gas which includes the primary combustion gas, secondary combustion gas and any additional gas that is introduced which is combustible. Preferably, the secondary combustion gas makes up between 10 to 50%, preferably 20 to 40% of the total percentage of combustion gas.

In a preferred embodiment, an additional (or secondary) liquid or gaseous fuel is injected into the central region 24, and burns in the presence of the secondary combustion gas to form a flame in the central region 24. The relative amounts of the oxygen in the secondary combustion gas and the secondary liquid or gaseous fuel are selected so that there is an excess of oxygen following complete combustion of the secondary fuel in the secondary gas.

The secondary fuel is preferably injected towards the lower end of the central region 24, preferably in the lower half of the chamber, so that it is close to the base region 26. The secondary fuel can be any liquid or gaseous fuel that combusts immediately and completely. Preferred fuels are propane, methane or natural gas. The secondary fuel is present in a lower amount than the particulate fuel and makes up less than 40%, typically 5 to 15% of the total fuel energy.

In an embodiment the secondary combustion gas is pure oxygen and is introduced through a burner inlet 18 with the fuel so that combustion occurs immediately. Alternatively, the secondary combustion gas can be introduced through an inlet 18 close to a separate fuel inlet for the secondary fuel and mixing can take place in the chamber 20.

Once the mineral melt reaches the melt pool 30 it is heated by submerged heater, in the shown embodiment submerged combustion heaters 40. This direct heating provides further control over the temperature of the melt pool 30, but also acts to increase the homogeneity of the melt within the melt pool 30. In particular, the submerged combustion heaters 40 cause turbulence within the melt pool 30. This results in a mixing effect within the melt pool 30, acting to increase the consistency of the molten material both in terms of temperature and composition.

In order to enable the mixing effect of the combustion heaters 40 to take effect, the residence time of the molten material 30 within the chamber 20 is preferably relatively large. For example, material may be resident within the chamber for more than ten minutes on average, and more preferably more than fifteen minutes on average.

The residence time may be adjusted by adjusting the rate at which particulate mineral material is introduced into the chamber 20 and by the rate at which the mineral melt is extracted. It will also depend on the depth and overall volume of the melt pool 30, since this affects the effective path over which the material travels before extraction from the chamber. Thus, the siphon can be arranged to provide a preferred depth of the melt pool. It is found in practice that a depth of at least 15 cm is preferable, more preferably at least 20 cm. In preferred embodiments, a depth of between 30 cm and 50 cm may be adopted. This provides a sufficient residence time for the mixing effect of the submerged combustion process to ensure adequate homogeneity in the melt.

A further advantage of the submerged combustion process is that it may be used to control the relative proportions of different iron oxidation states within the melt. In particular, it is found that a heightened proportion of Fe(2+) relative to Fe(3+) within the melt produces a melt particular suitable for centrifugal fiberising processes such as spinning cup or cascade spinner processes. In particular, MMVF formed from a melt containing relatively high levels of Fe(2+) are found to result in fibres that have improved high temperature stability as compared with fibres having a lower proportion of Fe(2+) and a higher proportion of Fe(3+).

The desire to increase the proportion of Fe(2+) contrasts with some glass production techniques which are often designed to increase the relative Fe(3+) proportion, since this results in clearer glass products which are often desired.

The relative proportions of Fe(2+) and Fe(3+) resulting from the submerged combustion process are at least in part dependent upon the amount of oxygen and fuel introduced into the melt by the submerged combustion process. It is therefore possible to obtain a desired result by setting these ratios appropriately. Typically, increased oxygen supply may result in a higher proportion of Fe(3+) while increased fuel supply may increase the relative proportion of Fe(2+) due to less oxidising conditions. It will be understood that the residence time of the melt within the chamber will also play a part, since this will affect the impact of the submerged combustion process on the relative proportions of Fe(2+) and Fe(3+).

In the preferred embodiment, the submerged combustion process is managed such that the proportion of Fe(2+) based on total Fe within the melt extracted at the siphon is greater than 80%, preferably greater than 90%, more preferably greater than 95%, most preferably greater than 97%.

As mentioned above, after an appropriate residence time within the chamber 20, the melt is extracted via the siphon 50. As is normal with a siphon, the result is that, in order for the melt to leave the chamber, the melt pool 30 inside the chamber must be deep enough to reach the vertically highest point of the siphon outlet barrier 56. When this happens, gravity causes the melt to pass up through the upwardly oriented part of the siphon 50 and then flow down the subsequent part of the siphon 50 to the fiberising equipment 60. Hence, this creates an air-lock in the system which ensures that exhaust gases cannot escape from the chamber 20 through this route, instead being expelled from the chamber 20 via the exhaust outlet 16.

Using a siphon 50 is particularly advantageous in the embodiment where a particulate fuel, such as coal, is used and leads to improvements in the melt quality. This is due to the fact that char particles, which are fuel particles that have not combusted completely, may collect on top of the melt pool 30 and float there. These char particles are prevented from exiting the chamber 20 with the melt by the siphon 50 since the opening 52 is lower than the height of the outlet barrier 56.

By enabling the char particles to collect on the melt pool 30, their residence time in the chamber 20 is increased compared to when a siphon 50 is not used. Hence, the char particles can complete their combustion in the base region 26 to achieve full burn-out of the fuel. This ensures that the energy efficiency of the process is optimised.

A further advantage relates to the relative proportions of Fe(2+) and Fe(3+) in the melt. As mentioned above, it is preferable to encourage a large Fe(2+) content in the melt in order to increase the high temperature stability of MMVF produced. By using a siphon 50 to increase the contact time of the melt pool 30 with floating char particles the proportion of Fe(2+) can be increased. This is because the char particles are themselves highly reducing, and can thus act to reduce the Fe(3+) in the melt to Fe(2+), thereby assisting in the achievement of the desired proportion of Fe(2+).

Once extracted from the siphon 50, the melt is passed to the centrifugal fiberising apparatus 60, where it is transferred into fibres. As mentioned above, the centrifugal fiberising apparatus 60 may, for example, be a spinning cup or a cascade spinner. Although a single centrifugal fiberising apparatus is shown in FIG. 1, the skilled person will recognise that the siphon may feed multiple apparatus with melt if so desired. The centrifugal fiberising apparatus produces man-made vitreous fibres (MMVF) which have many industrial and commercial applications. For example, the resulting MMVF is particularly suited for use as thermal and/or fire insulation material or as a growth substrate for plants.

The siphon 50, and in particular the barrier outlet 56, is preferably adjustable in height. This allows the height of the melt pool 30 to be adjusted, which can affect properties such as the residence time of mineral material in the chamber 20 and consequently the amount of homogenisation achieved by the submerged combustion process. In one embodiment the height position of the siphon 50 can be adjusted to be located below the submerged combustion heaters 40. This is useful during start up and closing down of the melting process, since it allows the submerged combustion heaters 40 to be out of the melt pool 30 during these stages. Thereby it is effectively ensured that the submerged combustion heaters 40 do not become clogged by molten mineral material.

In the above process, it will be understood that various properties may be controlled in dependence on empirical measurements. In particular, it is desirable to achieve particular residence times for the mineral material within the chamber 20 and also to ensure the proportion of Fe(2+) in the melt extracted from the siphon 50 is within preferred bounds. Parameters of the process may be adjusted in response to measurements taken during the process to achieve desired results.

For example, the residence time may be calculated using a tracer material introduced in the particulate mineral material. This tracer material may be, for example, a chemical element not otherwise found in the feedstock for the particulate mineral material. Examples are ZnO and ZrSiO₄, but other tracer materials are also applicable. A known quantity of the tracer material may be introduced to the melt at a given time, and the melt output from the siphon can be analysed to establish the average time period during which the tracer material is within the chamber 20. The melt may be analysed by spectroscopic methods or other suitable techniques for identifying the tracer material. The average time period for the tracer material to exit the chamber 20 can be understood as the residence time for mineral material within the chamber. In this context, the average is the median; accordingly, the residence time can be understood as the time period required for half the tracer material to exit the chamber 20.

The residence time will be affected by parameters such as the rate of input of particulate mineral material and the height of the melt pool 30 (which can be controlled by using a siphon 50 whose position is adjustable in height). By measuring the residence time using tracer material as explained above, a suitable combination of process parameters for a desired residence time can be derived. Similarly, the effect of a given existing set of process parameters on the residence time can be understood.

As mentioned above, it is also preferably to ensure a desired proportion of Fe(2+) within the melt extracted by the siphon 50. This can be done by adjusting the various process parameters in dependence on measurements of the proportion of Fe(2+) in the output. One technique by which the proportion of Fe(2+) may be determined is through Mossbauer Spectroscopy as described in the “Ferric/Ferrous Ratio in Basalt Melt at Different Oxygen Pressures”, Helgason et al, Hyperfine Interact., 45 (1989) pp 287-294.

In the above description, an on-going process of producing melt is described. During the process, the melt pool 30 remains in place and a steady stream of melt is extracted and transferred to the centrifugal fiberising apparatus 60. However, the skilled person will appreciate that the system must first be initialised. That is to say, the melt pool must first be established. During this phase, the melt pool 30 may not reach the height of the submerged combustion heaters 40. It is possible not to start the combustion heaters 40 until it is submerged by the melt pool 30. However, in preferred embodiments, the heaters 40 are operated even when not submerged in order to ensure temperature consistency throughout the chamber and prevent the low melt pool 30 from solidifying or cooling more than is desirable. Furthermore, operation of the heaters 40 during this stage may reduce the risk of melt ingress into the heaters 40 that may affect their functionality.

Similarly, when the apparatus is shut down, the melt pool 30 may be emptied by progressive lowering of the outlet barrier 56 or by another technique. Again, the combustion heaters 40 may remain operable during this time to ensure the melt pool 30 even at low levels remains at an appropriate temperature.

Various modifications and alterations to the preferred embodiment will be apparent to the skilled person. In some alternative embodiments, for example, the submerged heaters 40 are electrode heaters. That is to say, one or more cathode and anode pairs are provided disposed within the melt pool 30. A potential difference applied between the cathode-anode pairs induces a current across the melt pool. The relatively high resistance of the melt pool 30 causes significant energy loss to heat within the pool 30, thereby acting to raise the temperature of the pool 30 and provide the advantages of the heating means explained above. In particular, the raised temperature encourages turbulence within the pool 30, leading to increased temperature and composition homogeneity.

The electrodes may extend vertically upwards from the bottom of the chamber 20 as this ensures good stirring and homogeneity of the melt. In other examples, the electrodes may extend horizontally through the side walls of the chamber 20, or at an angle between vertical and horizontal. Preferably, the electrodes are formed of molybdenum. This material is particularly appropriate with a high relative content of Fe(2+) to metallic iron and Fe(3+) since Fe(2+) is not as aggressive on molybdenum as the other Fe states. The electrodes preferably extend 10 to 30 cm from the bottom of the chamber 20, while the melt bath has a height in preferred embodiments of 30 to 50 cm. Generally, the electrodes should be completely covered by the melt pool 30 during use.

In another alternative embodiment the secondary inlets 18 are dispensed with and the only heating of the melt pool 30 is by submerged heating. The advantage of this is prolonged service life of the lining inside the combustion chamber 20, since this can be strongly worn by the extreme heat radiation from the burning lances 18. By using only submerged heating the lining inside the combustion chamber 20 is only worn by the less extreme heat of the mineral melt.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination.

It should be noted that the term “comprising” does not exclude other elements or steps, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present invention.

1. A method of making man-made vitreous fibres (MMVF), comprising:
providing a circulating combustion chamber;
injecting particulate fuel, particulate mineral material and primary combustion gas into an upper region of the combustion chamber and combusting the fuel, thereby melting the particulate mineral material to form a mineral melt;
collecting the mineral melt in a base region of the combustion chamber;
heating the collected mineral melt in the base region of the combustion chamber by submerged heating;
extracting the collected mineral melt from the combustion chamber via an outlet comprising a siphon; and
forming MMVF from the extracted mineral melt.

2. A method according to claim 1, wherein the step of submerged heating of the collected mineral melt comprises electrode heating of the collected mineral melt.

3. A method according to claim 1, wherein the step of submerged heating of the collected mineral melt comprises carrying out a submerged combustion process within the mineral melt.

4. A method according to claim 3, wherein the submerged combustion process comprises the injection of additional fuel and combustion gas through one or more burner lances extending through one or more sidewalls of the combustion chamber.

5. A method according to claim 4, wherein the burner lances are angled downwardly from the sidewalls of the combustion chamber.

6. A method according to claim 1, wherein the position of the siphon is adjustable in height.

7. A method according to claim 1, wherein the primary combustion gas is oxygen-enriched air which contains at least 25% oxygen by volume.

8. A method according to claim 1, further comprising the step of injecting a secondary combustion gas above the mineral melt, thereby inducing combustion of char produced by pyrolysis of the particulate fuel.

9. A method according to claim 8, wherein the secondary combustion gas is oxygen-enriched air which contains at least 25% oxygen by volume.

10. A method according to claim 1, wherein the step of forming the MMVF is carried out using a centrifugal fiberising apparatus.

11. A method according to claim 10, wherein the centrifugal fiberising apparatus is a spinning cup.

12. A method according to claim 10, wherein the centrifugal fiberising apparatus is a cascade spinner.

13. A cyclone furnace, comprising
a circulating combustion chamber;
one or more inlets for injecting particulate fuel, particulate mineral material and combustion gas into an upper region of the combustion chamber for combusting the fuel, thereby melting the particulate mineral material to form a mineral melt which collects in a base region of the combustion chamber, wherein the chamber is integrally formed and the base region is not provided separately;
submerged heating means for directly heating the collected mineral melt in the base region of the combustion chamber; and
an outlet for extracting the collected mineral melt from the combustion chamber, wherein the outlet comprises a siphon.

14. A cyclone furnace according to claim 13, wherein submerged heating means for directly heating the collected mineral melt comprises electrodes.

15. A cyclone furnace according to claim 13, wherein the submerged heating means for directly heating the collected mineral melt comprises one or more burner lances for carrying out a submerged combustion process within the mineral melt.

16. A cyclone furnace according to claim 15, wherein the one or more burner lances extends through one or more sidewalls of the combustion chamber.

17. A cyclone furnace according to claim 16, wherein the burner lances are angled downwardly from the sidewalls of the combustion chamber.

18. A cyclone furnace according to claim 13, wherein the position of the siphon is adjustable in height.

19. A cyclone furnace according to claim 13, comprising an exhaust outlet for carrying exhaust gases from the chamber, wherein the exhaust outlet is formed through the top of the chamber.
